(19) United States
(12) Patent Application Publication
(10) Pub. No.: US 2018/0137585 A1
(43) Pub. Date: May 17, 2018

(54) ESTATE PLANNING AND ADMINISTRATION

(71) Applicant: RATTLEHUB DIGITAL (PTY) LTD, Southdowns (ZA)

(72) Inventor: Marius VAN NIEKERK, Irene (ZA)

(21) Appl. No.: 15/564,427

(22) PCT Filed: Apr. 7, 2016
(86) PCT No.: PCT/IB2016/051956

§ 371 Date: Oct. 4, 2017

(30) Foreign Application Priority Data
Apr. 7, 2015 (ZA) 2015/02200

(51) Int. Cl. G06Q 50/18; G06Q 50/00; G06Q 10/10

(52) U.S. Cl. CPC G06Q 50/186; G06Q 10/10; G06Q 50/01

(57) ABSTRACT

An estate management platform for administering estate data of a person, which includes a remote access interface for receiving incoming data connections, the remote access facility having secure data access facility and being operable to access an estate database and an estate database, including a predefined structure of estate categories for storing estate data of a person in predefined estate categories.

### FIELD OF THE INVENTION

This invention relates to estate planning and administration. In particular, the invention relates to a method of managing an estate of a living person, to a method of managing an estate of a deceased person and to an estate management platform.

### BACKGROUND OF THE INVENTION

The inventor has identified an opportunity in the market where a person can manage their personal portfolio in preparation for death. It is an aim of the invention to provide a platform that will assist the user in managing his/her portfolio and in doing so to place his/her affairs in order for the effective administration of his/her deceased estate.

The inventors thus identified a particular requirement for a platform that hosts data related to a person's end of life arrangements and that manages such arrangements proactively, while the person is alive. The present invention's objective is to address this particular requirement.

### SUMMARY OF THE INVENTION

According to one aspect of the invention, there is provided a method of managing an estate of a living person, which includes
providing a predefined structure of estate categories of a person which is to be populated with data;
receiving data related to the person's estate into the structure of estate categories;
presenting a measure of completeness of the received estate data to a user, the measure of completeness being representative of the number of data fields completed in the predefined structure. It is to be appreciated that the measure of completeness cannot provide and indication of the correctness of information nor if all the required data in a person's portfolio has been provided.

The method may include storing electronic copies of estate documents.

The term estate categories in this specification are used to refer also to personal portfolio categories, for example assets and liabilities of a person or any other aspects forming part of a person's portfolio.

The predefined structure of estate categories may include a combination of one or more of the following data categories:
an overview dashboard providing an overview of the captured estate data;
basic data of the person;
family data of the person;
estate data of the person;
profession data of the person;
portfolio data of the person;
accounts data of the person;
social data of the person; and
sharing permissions.

The method may include providing an explanation of what questions to expect for completing the category, benefits of completing data in a particular category, handy tips for completing the category and documents required to complete a particular category.

The aim of the overview dashboard is to provide an easy to access and user friendly interface to a user which dynamically indicates progress in the method, provides educational content, provides relevant advertising content and most prominent shortcomings in the data completeness, also referred to “mind the gap”. The method may thus include automated advisory services based on the information provided, generally referred to as “robo-advice” which refers to an online wealth management service that provides automated, algorithm-based portfolio management advice without human intervention.

The overview dashboard may include a measure of completeness of the data received from the person in terms of basic data of the person, family data of the person, estate data of the person, profession data of the person, portfolio data of the person, accounts data of the person and social data of the person.

The measure of completeness may be represented as any one of a percentage score and a graphical representation.

The may include a definition of a predefined set of trigger events, which may prompt a person to update his/her data.

The trigger events may include any one of purchasing an asset, entering into marriage or a relationship, death, divorce, birth of a baby, change in dependent status, support to parents, retirement, disability, critical illness, loss of employment, sequestration or debt counselling, death of a spouse, starting a business, or the like.

The basic data may include any one or more of the following:
personal details;
travel documents;
addresses;
relationship status; and
a sharing definition.

The sharing definition may be populated with a list of people who are authorized to access information or to whom information may be send. The definition may include a definition of access rights which the users may hold, such as “None”, “View Only” and “View & Edit” access rights.

The travel documents may include current passports and visas. Conveniently the method may include a travel tracker, which records a travel history of a user by means of an automated mobile telephone application or data fields into which previous and future travel can be entered. This feature will be of particular benefit for future travel document applications.

The family data may include any one or more of the following:
own family data;
spouse/partner family data;
children(s) data;
parent(s) data;
dependent(s) data;
employee(s) data; and
pet(s) data.

The estate data may include any one or more of the following:
a person's will (domestic will or international will);
a person's trust(s);
a person's executor;
appointed guardians;
a person's heirs;
data of a person's previous marriages; and
special wishes of a person, such as wishes at the funeral, special video recordings.

In particular, the estate data may include a letter of wishes.

The profession data may include any one or more of the following:
professional qualifications;
work data;
tax data; and
medical data.

The portfolio data may include any one or more of the following:
insurance cover data;
banking details;
investment details;
details of fixed property;
licensed asset data;
unlicensed asset data;
home loan data;
loan data; and
contingencies.

The accounts data may include any one or more of the following:
credit card data;
shopping account data;
municipal account data;
loyalty program data;
housing account data;
business account data;
transportation account data;
healthcare account data;
education and support account data;
communication and technology account data.

The social data may include any one or both of social media account data, association data and membership account data. The social data may include a list of charitable organisations to which a person are contributing or that a person want to contribute to.

The method may include providing an access code to an executor in event of a particular occurrence, such as death.

The method may include providing to a user a document gallery, through which all documents captured in accordance with the method can be accessed. The method may include an electronic mail facility by means of which documents from the document gallery can directly be forwarded. Advantageously, this facility may be used by a person to provide information that may be required by government or private organisations to comply with financial intelligence requirements.

The method may include associating expiry dates with estate documents.

The method may include transmitting an expiry notification to a user if an expiry date of an estate document fall within a predefined period in future.

According to another aspect of the invention, there is provided a method of administering an estate of a deceased person, which includes
managing an estate of a person as described above;
providing access to data stored in the management of the estate to an executor.

The method may include providing a predefined structure within which the estate can be administered.

The method may include
recording data of the person's death;
recording data associated with the identification of a body of the deceased person;
recording of a death notice of the deceased person;
forwarding of the death notice to a department of home affairs;
receiving death certificate from the department of home affairs.

Providing a predefined structure may include any one or more of:
generating predefined documentation for the administration of the estate;
providing a diary system for administration of the estate;
generation of a liquidation/distribution account;
providing automated calculation of estate duties and fees; and
automated calculation of capital gains tax, income tax, and the like.

The method may include data fields in which expenses for renovations to property can be recorded for future capital gains tax calculations.

The method may include generating leads to financial service providers.

Generating leads may include identifying shortcomings in estate data and sending a notification to a prospective service provider of the shortcoming.

According to another aspect of the invention, there is provided a method of administering an estate of a deceased person, which includes
receiving and capturing a person's personal data and will onto an estate administration platform while the person is alive;
upon death of the person, releasing at least some of the person's personal data and the person's will to a predefined party, such as an executor of the person's estate.

The method may include the prior step of reminding a person to have a will drafted.

The method may in addition provide a checklist of legal requirements for the will to be valid.

The method may include providing a draft of a living will to a person as well as a location of where the will is stored or from which the will can be obtained.

The predefined party may be any one of an executor of the person's estate, a third party business and a governmental institution, such as a master of the High Court, the revenue services, or the like.

The method may include receiving and capturing a person's living will.

The living will may include any one or more of a letter of wishes, video messages, photographic images, preferred wishes for burial/cremation, preferred place of burial, wishes for the disposal of ashes which represent further data related to the person's final wishes.

The method may include evaluating the completeness of a person's personal data against a predefined standard to generate a measure of completeness of the person's personal data on an estate management platform.

The method may include, at predefined intervals, prompting a person to improve the measure of completeness by capturing further personal data of the person.

The method may include updating the person's data at regular intervals.

The method may include compiling a person's data at regular intervals. improve the measure of completeness by capturing The method may also include a “new year's resolution” tracker linked to the “bucket list” of objectives for objectives to be achieved in the coming year.

The method may include informing the predefined party, such as a nominated executor, when the person passes on.

The method may include hosting a list of contacts to be contacted in event of death of the person.

The method may include transmitting a death notification and contact details of the predefined party to contacts hosted in the list of contacts in event of death of the person.

The method may include receiving a request for the release of data from the selected party. The request may be accompanied by a death certificate of the person.

Releasing at least some of the person's personal data and the person's will to a predefined party may include providing access to the selected party to the person's personal data on the estate management platform.

The method may include referring the person to third party service providers, such as executors, banks, insurance providers, and the like.

The method may include receiving a referral fee for referrals to third party service providers.

The method may include providing educational data to a person related to the data that is requested from the person.

The method may include generating reminders to a person of data that is about to expire, so as to prompt the person to update the data. For example, the method may include generating reminders of a driver's license, which is to expire, generating reminders of bank cards that is to expire, or the like.

The method may include making certain electronic copies of documents available to a person for ease of reference.

The method may include providing an executor with an electronic console/display, which any one or more of the following functional fields:

Requests the Master of the High Court to appoint him/her as the Executor, by copying the death certificate and other data as required by the relevant Act;
notifications to selected contacts;
notifications to predefined governmental institutions;
provisional liquidation and distribution accounts;
notices to be placed in the Government Gazette and in other publications;
generation of standard letters as prescribed by law;
generation of final liquidation and distribution accounts;
communication interface with the Master of the High Court; and
communication interface with the Revenue Services.

The invention extends to an estate management platform for administering estate data of a person, which includes
a remote access interface for receiving incoming data connections, the remote access facility having secure data access facility and being operable to access an estate database;
an estate database, including a predefined structure of estate categories for storing estate data of a person in predefined estate categories.

The estate management platform may include a predefined release party data field defining a party to which data from the estate database are to be released upon death of the person.

The estate management platform may include a measure of completeness indicator, the measure of completeness indicator being representative of the readiness of the estate to be administered in event of death of a person and being in the form of any one or a score and a graphical representation.

The estate management platform may include a social media sharing interface through which predefined aspects of the data on the platform may be shared. For example the measure of completeness indicator may be shared through the social media sharing interface.

The estate management platform may include a business intelligence facility operable to collate information of multiple estates and to supply summaries/analysis of the multiple estates to a third party service provider, such as a business partner.

The estate management platform may include a document storage facility in the form of a document gallery for storing and accessing electronic copies of estate documents.

The predefined structure of estate categories may include a combination of one or more of the following data categories:
an overview dashboard providing an overview of the captured estate data;
basic data of the person;
family data of the person;
estate data of the person;
profession data of the person;
portfolio data of the person;
accounts data of the person;
social data of the person; and
sharing permissions.

The estate management platform may include a portfolio snapshot which includes a summary of the estate of a person, showing a summarised version of any of the data in the estate database.

The estate management platform may include an assessment facility which identifies prominent shortcomings in the data completeness, also referred to “mind the gap”. The assessment facility may include a risk profiling facility which provides a profile of the risk caused by such incompleteness or shortcomings.

The estate management platform may include safe access information, such as a code for a physical safe or a location where a safe key is stored.

At least some of the categories may include an explanation of what questions to expect for completing the category, benefits of completing data in a particular category, handy tips for completing the category and documents required to complete a particular category.

The overview dashboard may include a measure of completeness of the data received from the person in terms of basic data of the person, family data of the person, estate data of the person, profession data of the person, portfolio data of the person, accounts data of the person and social data of the person.

The measure of completeness may be represented as any one of a percentage score and a graphical representation.

The estate management platform may include a definition of a predefined set of trigger events, which may prompt a person to update his/her data.

The trigger events may include any one of purchasing an asset, entering into marriage or a relationship, death, divorce, birth of a baby, change in dependent status, support to parents, retirement, disability, critical illness, loss of employment, sequestration or debt counselling, death of a spouse, starting a business, or the like.

The basic data may include any one or more of the following:
personal details;
travel documents;
addresses; and
relationship status; and
a sharing definition.

The sharing definition may be populated with a list of people who are authorized to access information or to whom information may be send. The definition may include a definition of access rights which the users may hold, such as “None”, “View Only” and “View & Edit” access rights.

The family data may include any one or more of the following:
own family data;
spouse/partner family data;
children(s) data;
parent(s) data;
dependent(s) data;
employee(s) data; and
pet(s) data.

The estate data may include any one or more of the following:
a person's will (domestic will or international will);
a person's trust(s);
a person's executor;
appointed guardians;
a person's heirs;
data of a person's previous marriages; and
special wishes of a person, such as wishes at the funeral, special video recordings.

The trusts may include data fields that include financial aspects of the person's trust(s).

The estate data may include data fields that contain information relevant to the establishment of testamentary trusts, trustees and beneficiaries.

The profession data may include any one or more of the following:
professional qualifications;
work data;
tax data; and
medical data.

The portfolio data may include any one or more of the following:
insurance cover data;
banking details;
investment details;
details of fixed property;
licensed asset data;
unlicensed asset data;
home loan data;
loan data; and
contingencies.

The accounts data may include any one or more of the following:
credit card data;
shopping account data;
municipal account data;
loyalty program data;
housing account data;
business account data;
transportation account data;
healthcare account data;
education and support account data;
communication and technology account data.

The social data may include any one or both of social media account data, association data and membership account data. The social data may include a list of charitable organisations to which a person are contributing or that a person want to contribute to.

The estate management platform may include an expiry indicator for associating an expiry date to an estate document.

The estate management platform may include a notification facility, operable to test the expiry indicator and to transmit an expiry notification to a user if an expiry date of an estate document falls within a predefined period in future.

In one embodiment, the secure data access facility may include a predefined username and password issued to authorized users of the system. In a preferred embodiment the secure data access facility may form part of an application program interface of another business system. For example, access may be provided via the secure access facility of a third party business system. This embodiment would be of particular relevance in a so called business-to-business application, i.e. to which the estate management platform can be added as a business system enhancement.

The predefined username/password may provide access only to the estate database of a specific person associated to the predefined username and password.

At least some of the data fields may be associated with an electronic document that represents the data in the data field.

The electronic document may be in the form of a scanned copy of a physical document.

The data field may include an indication of the authenticity of the document, such as a document certified as an original by a commissioner of oaths, a notary public, or the like.

At least some of the data fields may include an additional data field indicating the physical location where the original of the electronic document is stored.

The estate management platform may include a communications interface arranged to interface directly with statutory institutional databases. For example, the repository may include a specific predefined communication protocol for each statutory institution. The communication protocol may be in the form of an application programming interface (API) between the various components of the system. For example, a statutory institution may include the master of the High Court, the Revenue services, or the like.

The communications platform may be operable to present data from the the estate database to a statutory institution in a predefined format, such as prepopulated on a predefined form prescribed by the statutory institution or via a data transfer into a database of a statutory institution.

The estate management platform may form part of any one of a business-to-business application and a business-to-client referral platform, from which referals are generated based on the data stored on the platform.

The estate management platform may include contact details of reputable service providers. The service providers may be pre-cleared or pre-authorized to provide services to persons registered onto the estate management platform.

The estate management platform may include an emergency diagram indicating any one or more of the following data field extracted from the estate database: family member emergency contact details, address details, existing wills, existing trusts, key contact details, guardian details, business/work contact details, details of trusteeships, bank emergency contact details, pension fund details, policy details and a list of notable assets.

The invention will now be described by way of a non-limiting example only, with reference to the following drawing.

### DRAWINGS

In the drawings:

FIG. 1 shows an estate management platform in accordance with one aspect of the invention;

FIG. 2 shows a method of administering a deceased estate of a person in accordance with another aspect of the invention;

FIG. 3 shows a screenshot of a dashboard of the platform if FIG. 1;

FIG. 4 shows a screenshot of a basic data input screen of the platform of FIG. 1;

FIG. 5 shows a screenshot of a family data input screen of the platform of FIG. 1;

FIG. 6 shows a screenshot of an estate data input screen of the platform of FIG. 1;

FIG. 7 shows a screenshot of a profession data input screen of the platform of FIG. 1;

FIG. 8 shows a screenshot of a portfolio data input screen of the platform of FIG. 1;

FIG. 9 shows a screenshot of an accounts data input screen of the platform of FIG. 1;

FIG. 10 shows a screenshot of a social data input screen of the platform of FIG. 1; and

FIG. 11 shows a screenshot of an emergency diagram setting out the various types of data that would be necessary in event of death of a person.

### EMBODIMENT OF THE INVENTION

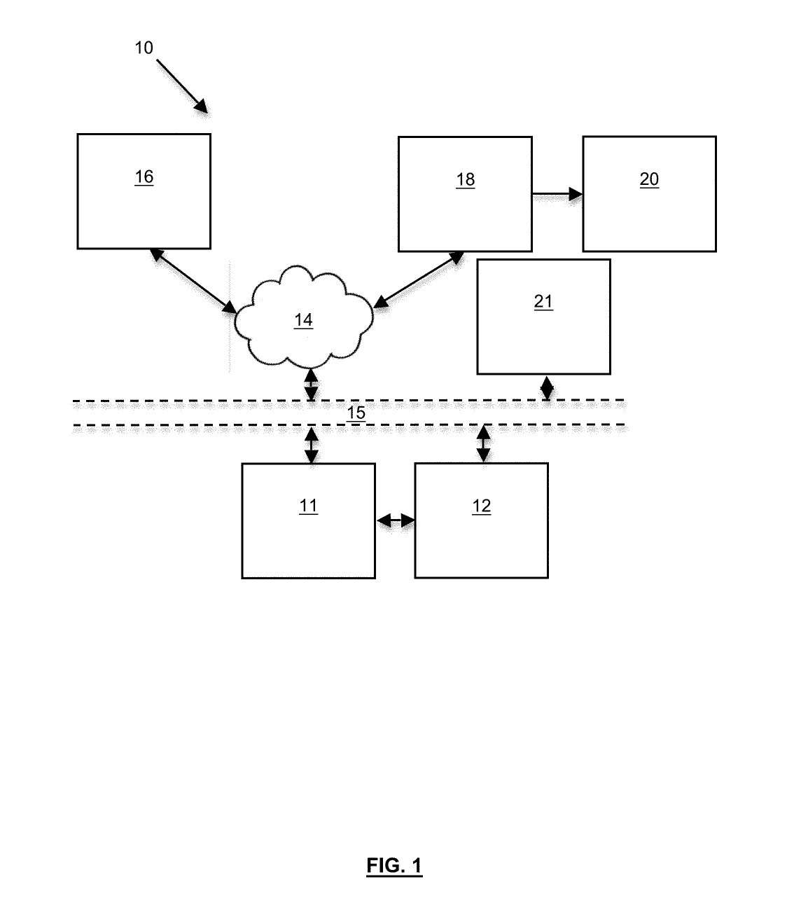

FIG. 1 shows an estate management platform 12 in accordance with one aspect of the invention is shown in use in an operational arrangement 10.

The estate management platform 12 includes a database having a remote access interface which is connectable to the Internet 14 via an application program interface (API) 15, and accessible by third parties, such as a person 16 who wants to update his/her data on the database, a selected third party, such as an executor 18 of the person's estate. Governmental third parties 20, such as the master of the High Court, the revenue services, or the like can receive predefined data set extracts from the database from the executor 18 after the death of a person. It is to be appreciated that any of the components 12, 14, 16, 20 can also include an application program interface (API) (not shown) to enable it to communicate with the other components in the system. For example, the master of the High Court or the revenue services may have a dedicated API permitting them to interface to the executor system 18 to receive certain information which is needed to perform their function.

As shown in FIG. 1, the estate management platform 12 is connected at a backend to a business-to-business system 11, which provides other financial services to clients. In this example, the estate management platform is not directly connected to the Internet 14 for security purposes. The API 15 provides a secure data access facility through which secure access is provided to the estate management platform 12.

Other third party service provides 21 can also obtain access to the estate management platform 12 via the API 15.

FIG. 1 provides a so called “business-to-business” implementation of the system. It is to be appreciated that other implementation of the system is possible in which a business-to-client architecture can be defined without derogating from the generality of the invention.

The API implements secure access to the estate management platform 12.

The platform stores for each person 16 that is subscribed to the platform 12 at least a set of personal details, a will and contact details of a predefined party, such as an executor of the person's estate.

In this instance the personal details of the person includes:
Full names and contact details of the person;
Family details, such as spouse data and dependent's data;
Medical details of the person;
Banking details of the person;
Financial assets and liabilities of the person;
Membership details of the person;
Investment details of the person;
Social media details of the person.

This data is obtained from the person by guiding the person through the steps of populating the database with the person's details or from being imported from another third party business system by means of which at least some of the data fields are pre-populated.

The database has data fields to store the data in a pre-arranged format, such as a structured query language (SQL) database.

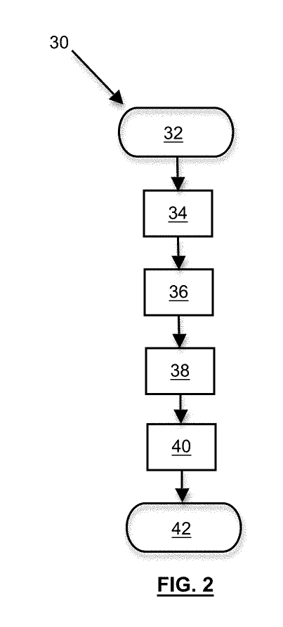

FIG. 2 shows a method 30 of administering a deceased estate of a person.

The method is initiated at 32 where a living person's personal details and will is captured onto the estate management platform. The person is reminded to have a will drafted, if a will does not exist. This step also includes a checklist of legal requirements for the will to be valid. The person is reminded to update certain personal data to get the platform database as complete as possible.

If a person passes away the executor is contacted at 34 and requested to submit a death certificate, or the Administrator of the platform is contacted directly by relatives, to trigger release of an access code to a predefined person such as an executor to enable the executor to access the data. Alternatively the data can be forwarded to a predefined person in a physical format.

At 36 the data is released to the executor.

At 38 all the pre-loaded contacts are contacted to inform them of the death of the person. This step also includes the formal contacts such as the Master of the High court and the Revenue services.

At 40 a provisional liquidation and distribution account is generated. This is followed by a final liquidation and distribution account.

At 42 the estate is finalised upon submission of the necessary documents to the master of the High Court and the revenue services.

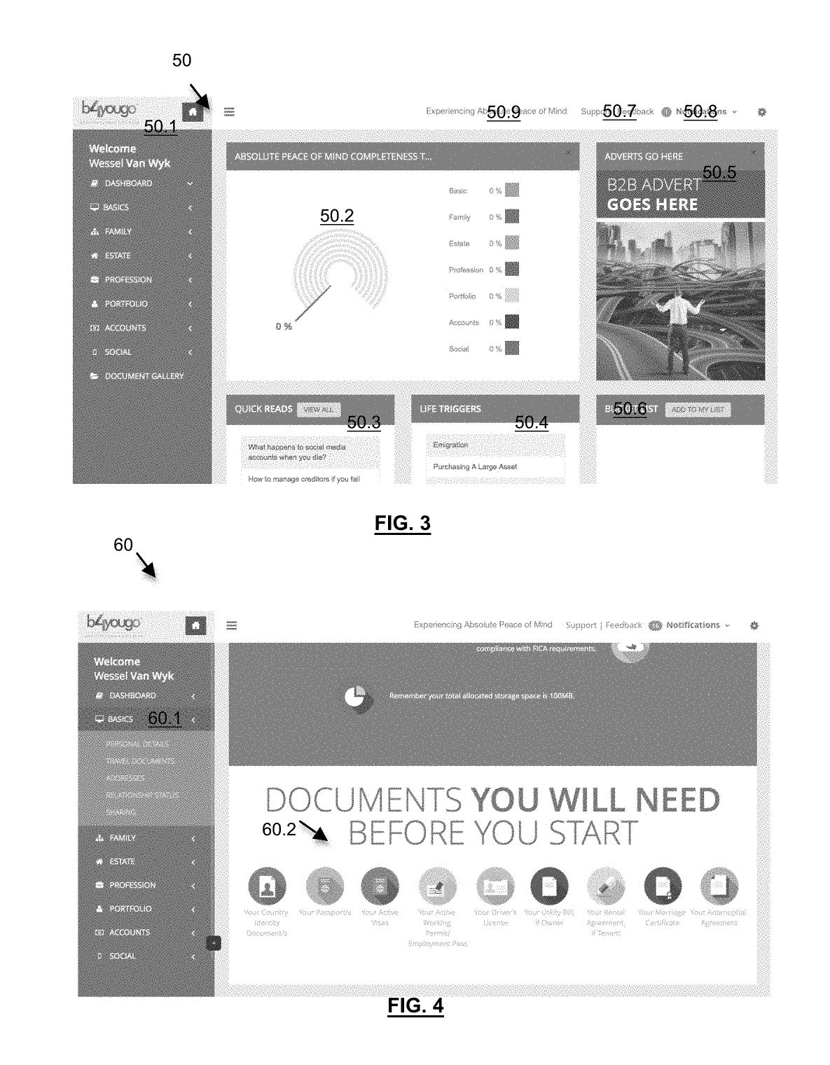

The input fields on the platform, which populate the data fields of the database, are shown in FIGS. 3 to 10.

It is to be appreciated that these input fields guide the person through the process of completing the data in a structured manner. The choices that a person selects via dropdown menus on the input fields determine the further input fields that are presented to a user.

FIG. 3 shows a dashboard 50, which displays a summary of all the personal data to a user of the system. In this Figure the following data is displayed to a user:
a side menu providing a structure of estate categories which has to be completed 50.1;
a measure of completeness of the data received from the user, in the form of a graphical indicator showing the measure of completeness of the separate categories separately 50.2;
educational articles as “Quick reads” 50.3;
a list of events that will trigger update/release of some of the data provided by the user 50.4;
advertising data 50.5;
a list of life goals marked “Bucket List” 50.6;
a Support/Feedback input link 50.7;
a Notifications indicator and dropdown link 50.8 which shows important notifications to a user (such as critical outstanding items);
a link to an overview of all the personal data that are required 50.9.

In FIG. 4 a basic data input screen 60 is shown, which includes a menu 60.1 of data that is to be completed in this category, such as personal details, travel documents, addresses, relationship status and sharing data.

At 60.2 a list of all data that are required in this category is shown, including Country Identity Documents, Passports, Active Visas, Active Working permits/Employment passes, Driver's license, Utility Bill, Rental Agreement, Marriage certificate and Antenuptial Agreement.

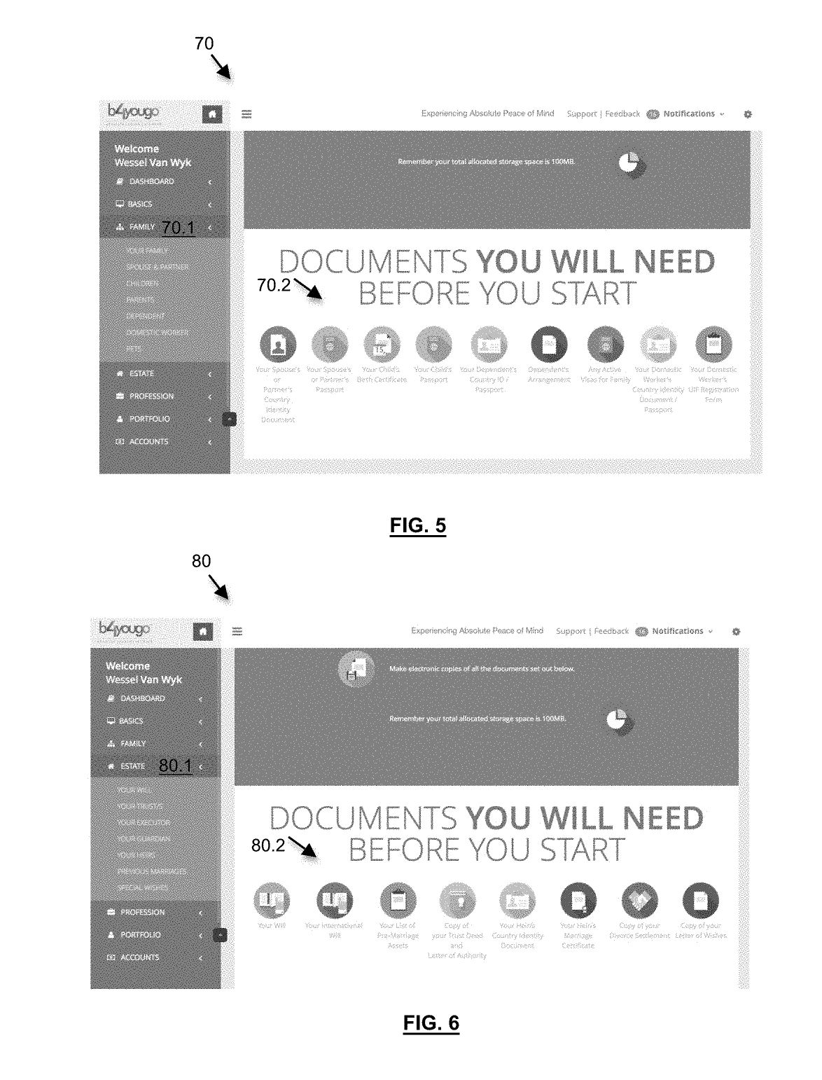

In FIG. 5, a Family detail input screen 70 is shown, which includes a menu 70.1 of data that is to be completed in this category, such as Family data, Spouse/Partner data, Children data, Parent data, Dependent data, Domestic worker/Employee's data and Pet data.

At 70.2 a list of all data that are required in this category is shown, including Spouse/Partner's Country Identity document, Spouse/Partner's Passports, Child's Birth Certificate, Dependent's Country ID/Passport, Any active Visas for Family members, Domestic Worker's Country Identity Document/Passport, Domestic Worker's UIF Registration Form.

In FIG. 6 an Estate input screen 80 is shown, which includes a menu 80.1 of data that is to be completed in this category, such as Will data, Trust data, Executor data, Guardian data, Heir data, Previous marriage data, Special Wishes.

At 80.2 a list of all data that are required in this category is shown, including A Will, An International Will, A list of pre-marriage Assets, A copy of a Trust Deed and Letter of Authority, Heir Country Identity Document, Heir Marriage Certificates, Copy of Letter of Wishes.

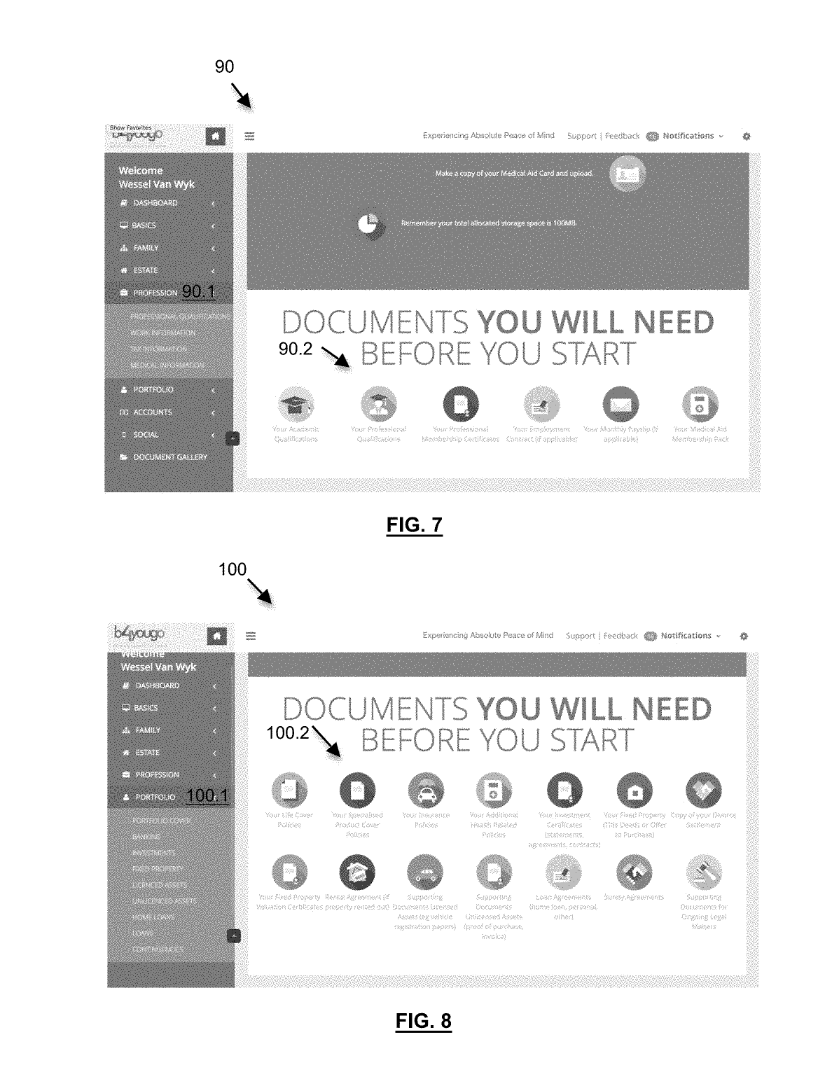

In FIG. 7 a Profession input screen 90 is shown, which includes a menu 90.1 of data that is to be completed in this category, such as professional qualifications, work data, tax data and medical data.

At 90.2 a list of all data that are required in this category is shown, including academic qualifications, professional qualifications, professional membership certificates, employment contract, monthly payslip and medical aid membership pack.

In FIG. 8 a portfolio input screen 100 is shown, which includes a menu 100.1 of data that is to be completed in this category, such as portfolio cover, banking data, investments, fixed property, licensed assets, unlicensed assets home loans, loans, contingencies.

At 100.2 a list of all data that are required in this category is shown, including life cover policies, specialised product cover policies, insurance policies, additional health related policies, investment certificates, fixed property, divorce settlement, fixed property valuation certificates, rental agreement, supporting documents-licensed assets, supporting documents-unlicensed assets, loan agreements, surety agreements, supporting documents for ongoing legal matters.

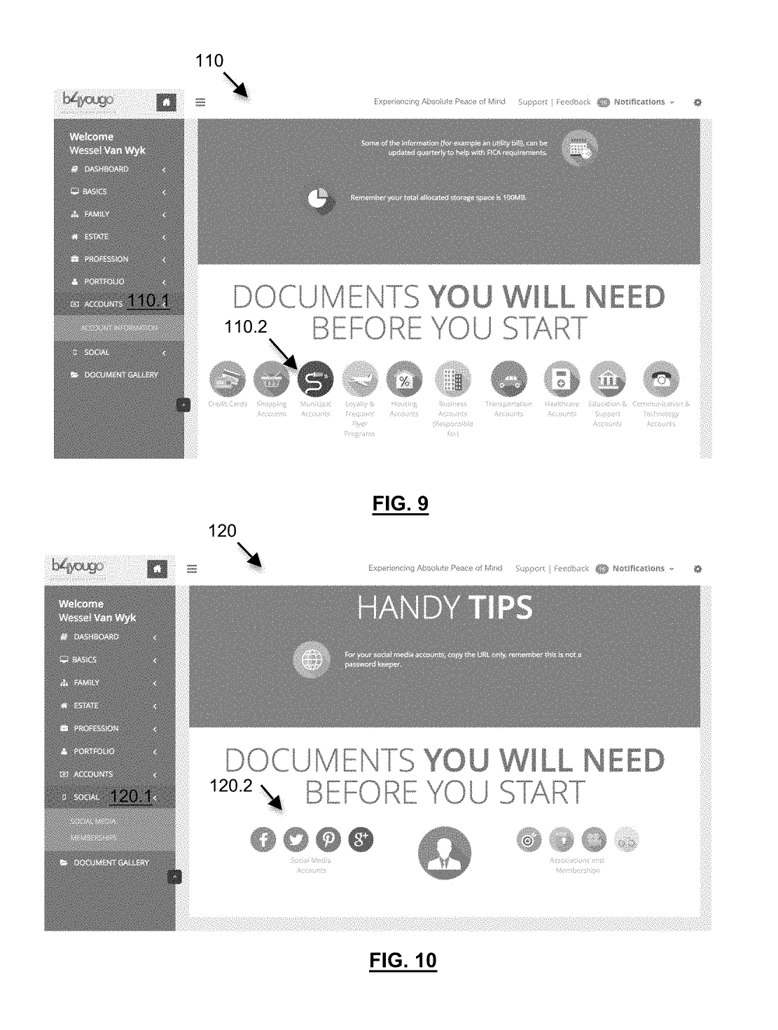

In FIG. 9 an account input screen 110 is shown, which includes a menu 110.1 of data that is to be completed in this category.

At 110.2 a list of all data that are required in this category is shown, including credit cards, shopping accounts, municipal accounts, loyalty accounts, housing accounts, business accounts which are payable, transportation accounts, healthcare accounts, education support accounts, communication and technology accounts.

In FIG. 10 a social input screen 120 is shown, which includes a menu 120.1 of data that is to be completed in this category, such as social media account data, and membership data.

At 120.1 a list of possible affiliations are shown, such as a Facebook account, a twitter account, a Pinterest account ,a google plus account, or other charitable organisations to which a person belong. Furthermore, all the details of membership associations are shown.

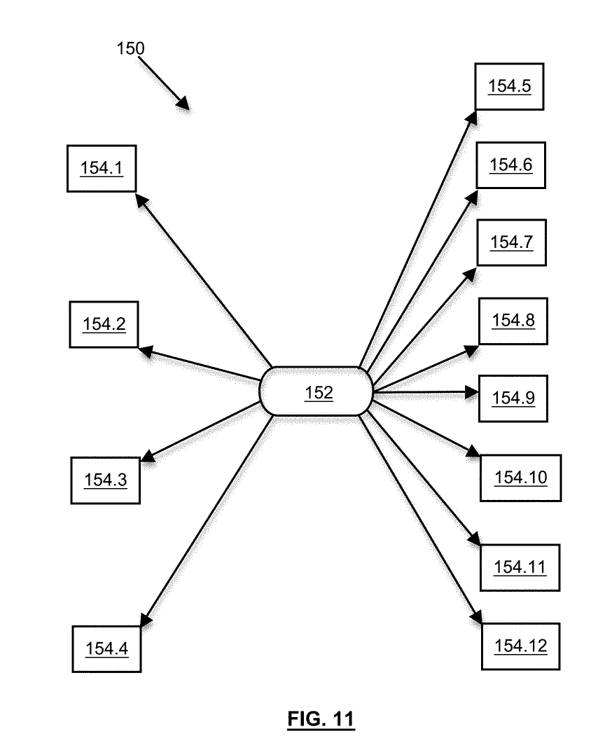

FIG. 11 shows an emergency diagram 150 of a person 152 which provides information extracted from the estate management platform database which represents emergency information that will be needed in event of death. the diagram 150 furthermore provides an overview of the data in the estate management platform database. The diagram includes information of family member emergency contact details 154.1, address details 154.2, existing wills 154.3, existing trusts 154.4, key contact details 154.5, guardian details 154.6, business/work contact details 154.7, details of trusteeships 154.8, bank emergency contact details 154.9, pension fund details 154.10, policy details 154.11 and a list of notable assets 154.12.

The inventor is of the opinion that the invention, as described provides a new estate management platform and a new method of administering an estate of a person while alive and after death. The platform can be utilised for a range of activities such as obtaining a banking loan, a mortgage bond, preparing for a holiday, etc.

In order to prevent any fraud on the platform or the method, it is specifically noted that the system does not store passwords that provide access to banking details or transactional accounts so that it is not possible to transact on behalf of the person by accessing any data in the platform database.

The inventor is of the opinion that the present invention provides a dynamic (being continually updated) and interactive (having a user friendly user interface) platform and method by means of which a person can manage his estate affairs. The information and users linked to the system provides a relationship platform for Financial advisors/bankers to ensure a focussed engagement. Furthermore, no other platform provides the facility to store estate related documents in a structured/predefined manner and no other system provides a measure of completeness of collected estate data. The fact that triggers are defined to prompt a person to update certain information is also unique and the automated advisory services (“robo-advisor”) has not been defined in any other estate management platform of which the inventors are aware.

The educational aspect of the invention, through which the platform provides educational tips/hints to a person has also not been seen in any other integrated estate management solution.

The built in reminder system by means of which documents' expiry date are tracked are also unique and provides the advantage of keeping records and documents up to date.

The built in referral system and pre-approved service provider database linking people in need of specific services to such service providers are unique and ensure that the risk in estate planning is reduced.

The specific functionality of estate data collection and social media interface thereof, specifically the sharing of measure of completeness are unique and not available on any other other existing social media platform.

The emergency diagram providing a high level overview of emergency data that would be needed in case of death is also unique and has not been seen in any other application.

The letter of wishes, video messages and documentation setting out end of life wishes are unique to the invention and are not available on any other integrated estate management platform of which the user is aware.

The fact that all the estate information is available immediately upon death of a person will lead to the reduction in time to wind up estates and the concomitant cost of winding up the estate.

The inventor further believes that the invention will provide peace of mind to the person and his/her next of kin, the invention provides a secure central repository where all data related to the end of a person's life and during the life of a person will be held. With this data at hand the steps to follow upon the passing of the person will be clearly set out and will facilitate the finalisation of the estate with a concomitant reduction in cost and time.

What is claimed is:

1. A method of managing an estate of a living person, which includes
providing a predefined structure of estate categories of a person which is to be populated with data, the predefined structure of estate categories including a combination of one or more of the following data categories:
an overview dashboard providing an overview of the captured estate data;
basic data of the person;
family data of the person;
estate data of the person;
profession data of the person;
portfolio data of the person;
accounts data of the person;
social data of the person; and
sharing permissions;
receiving data related to the person's estate into the structure of estate categories;
storing electronic copies of estate documents;
presenting a measure of completeness of the received estate data to a user, the measure of completeness being representative of the number of data fields completed in the predefined structure; and
providing an explanation of what questions to expect for completing the predefined structure of estate categories, benefits of completing data in a particular category, handy tips for completing the category and documents required to complete a particular category.

2.-4. (canceled)

5. A method as claimed in claim 1, in which the overview dashboard includes a measure of completeness of the data received from the person in terms of basic data of the person, family data of the person, estate data of the person, profession data of the person, portfolio data of the person, accounts data of the person and social data of the person, in which the measure of completeness is represented as any one of a percentage score and a graphical representation.

6. (canceled)

7. A method as claimed in claim 1, which includes a definition of a predefined set of trigger events, which may prompt a person to update his/her data, in which the trigger events include any one of purchasing an asset, entering into marriage or a relationship, death, divorce, birth of a baby, change in dependent status, support to parents, retirement, disability, critical illness, loss of employment, sequestration or debt counselling, death of a spouse and starting a business.

8.-14. (canceled)

15. A method as claimed in claim 1, in which the social data includes any one or both of social media account data, association data, membership account data and a list of charitable organisations to which a person are contributing.

16. A method as claimed in claim 1, which includes providing an access code to an executor in event of a particular occurrence, such as death.

17. A method as claimed in claim 1, which includes providing to a user a document gallery, through which all documents captured in accordance with the method can be either accessed or forwarded to an external user.

18. A method as claimed in claim 1, which includes associating expiry dates with estate documents and which includes transmitting an expiry notification to a user if an expiry date of an estate document fall within a predefined period in future.

19. (canceled)

20. A method of administering an estate of a deceased person, which includes
managing an estate of a living person as claimed in claim 1;
providing access to data stored in the management of the estate to an executor.

21. (canceled)

22. A method as claimed in claim 20, which further includes
recording data of the person's death;
recording data associated with the identification of a body of the deceased person;
recording of a death notice of the deceased person;
forwarding of the death notice to a department of home affairs;
receiving death certificate from the department of home affairs.

23. A method as claimed in claim 20, which further includes the steps of:
generating predefined documentation for the administration of the estate;
providing a diary system for administration of the estate;
generation of a liquidation/distribution account; and
providing automated calculation of estate duties and fees.

24.-25. (canceled)

26. A method of administering an estate of a deceased person, which includes
receiving and capturing a person's personal data and will onto an estate management platform while the person is alive;
upon death of the person, releasing at least some of the person's personal data and the person's will to a predefined party, in which the predefined party is any one of an executor of the person's estate, a third party business and a governmental institution; and
informing the predefined party when the person passes on.

27.-41. (canceled)

42. A method as claimed in claim 26, in which releasing at least some of the person's personal data and the person's will to a predefined party includes providing access to the selected party to the person's personal data on the estate management platform.

43.-47. (canceled)

48. A method as claimed in claim 26, which includes providing an executor with an electronic console/display, which any one or more of the following functional fields:
requests to a governmental institution be appointed as executor;
notifications to selected contacts;
notifications to predefined governmental institutions;
provisional liquidation and distribution accounts;
notices to be placed in the legislated media publication and in other publications;
generation of standard letters as prescribed by law;
generation of final liquidation and distribution accounts;
communication interface with the governmental institution; and
communication interface with the relevant Revenue Services.

49. An estate management platform for administering estate data of a person, which includes
a remote access interface for receiving incoming data connections, the remote access facility having secure data access facility and being operable to access an estate database;
an estate database, including a predefined structure of estate categories for storing estate data of a person in predefined estate categories, predefined structure of estate categories including a combination of one or more of the following data categories:
an overview dashboard providing an overview of the captured estate data;
basic data of the person;
family data of the person;
estate data of the person;
profession data of the person;
portfolio data of the person;
accounts data of the person;
social data of the person;
sharing permissions; and
a measure of completeness indicator, the measure of completeness indicator being representative of the readiness of the estate to be administered in event of death of a person and being in the form of any one or a percentage score and a graphical representation.

50.-53. (canceled)

54. An estate management platform as claimed in claim 49, which includes for at least some of the estate categories an explanation of what questions to expect for completing the category, benefits of completing data in a particular category, handy tips for completing the category and documents required to complete a particular category.

55.-56. (canceled)

57. An estate management platform as claimed in claim 49, which includes a definition of a predefined set of trigger events, which may prompt a person to update his/her data, the trigger events including any one of purchasing an asset, entering into marriage or a relationship, death, divorce, birth of a baby, change in dependent status, support to parents, retirement, disability, critical illness, loss of employment, sequestration or debt counselling, death of a spouse and starting a business.

58.-64. (canceled)

65. An estate management platform as claimed in claim 49, in which the social data includes any one or both of social media account data, association data and membership account data.

66. An estate management platform as claimed in claim 49, which includes an expiry indicator for associating an expiry date to an estate document.

67.-73. (canceled)

74. An estate management platform as claimed in claim 49, which includes a communications interface arranged to interface directly with statutory institutional databases, the communications platform being operable to present data from the estate database to a statutory institution in a predefined format, such as prepopulated on a predefined form prescribed by the statutory institution or via a data transfer into a database of a statutory institution.

75.-77. (canceled)

78. A method as claimed in claim 5, which includes generating leads to financial service providers, the leads based on shortcomings in estate data, the leads being generated by sending a notification to a prospective service provider of the shortcoming.

79. An estate management platform as claimed in claim 49, which includes a document storage facility in the form of a document gallery for storing and accessing electronic copies of estate documents.
